(19) United States
(12) Patent Application Publication
(10) Pub. No.: US 2007/0150481 A1
(43) Pub. Date: Jun. 28, 2007

(54) File distribution and access mechanism for file management and method thereof

(76) Inventors: Chen-Hwa Song, Taipei City (TW); Chih-Yin Lin, Tai-Ping City (TW)

Correspondence Address: J.C. Patents, Inc., Suite 250, 4 Venture, Irvine, CA, 92618, US

(21) Appl. No.: 11/403,432

(22) Filed: Apr. 12, 2006

(30) Foreign Application Priority Data
Dec. 27, 2005 (TW) 94146681

(51) Int. Cl. G06F 17/30

(52) U.S. Cl. 707/10

(57) ABSTRACT

A file access and management mechanism over Internet, and a method for distributing a file in arbitrary storage spaces and maintaining file security in the storage spaces are introduced herein. In addition, a method for maintaining file availability in the aforementioned storage spaces, a conversion manner between a network address and a virtual storage space address, and an addressing manner for determining addresses for placing file fragments are also introduced. The above storing manner also considers parameters at least including truth, availability, and size for choosing the storage space. And the present invention further provides a method for retrieving and deleting file fragments.

### CROSS-REFERENCE TO RELATED APPLICATION

This application claims the priority benefit of Taiwan application Ser. No. 94146681, Dec. 27, 2005. All disclosure of the Taiwan application is incorporated herein by reference.

### BACKGROUND OF THE INVENTION

1. Field of Invention

The present invention relates to a file access mechanism, and more particularly, to a mechanism for distributing a file in arbitrary storage spaces by using a network.

2. Description of Related Art

High-bandwidth transmission and wireless network connection have become a basic function gradually, and the fictions are implemented on handheld mobile devices, such as mobile phones, cameras, personal digital assistants (PDAs), personal handheld game machines, MP3 players, and portable multimedia players (PMPs). However, due to the limited physical size of the above devices, the capacity of the built-in memory or storage disk is always limited, resulting in that users cannot carry many favorite media, full personal data or business file information, and the like. Directed to the present high-bandwidth transmission network, operators in this field are providing various applications and resolutions.

For example, in U.S. Pat. No. 5,857,072 “System and method for distributing data simultaneously to multiple computers on a network, with advanced notice to intended recipients” published on Jan. 5, 1999, a Peer-to-Peer (P2P) sharing concept is provided, wherein when the data is determined to be distributed to a personal computer on a certain network, a message recording the correspondence between the data and the personal computer will be generated, and then the data is distributed over the network, such that the other personal computers know that the data can be read from this personal computer.

In U.S. Pat. No, 6,029,168 “Decentralized file mapping in a striped network file system in a distributed computing environment” published on Feb. 22, 2000, the balance between a storage space and a work load is considered to access files under a distributed network environment architecture. More than two file access managers are executed on different machines, the file blocks are determined to be stored in the machine according to the efficiency and storage space, or other file access managers are requested to transfer command, so as to share the work load. It is the same as the read of the file blocks, wherein the requirement is executed through different file access managers under consideration of load.

In U.S. Pat. No. 6,205,445 “File distribution system and method thereof” published on Mar. 20, 2001, an information management unit is provided, which automatically identifies which version of a file should be used in a certain hardware according to the correspondence between version information and hardware type. Therefore, when the file is installed, it is unnecessary to find out which version should be installed, instead, it is determined by the information management unit.

In U.S. Pat. No. 6,636,879 “Space allocation in a write anywhere file system” published on Oct. 21, 2003, a consideration for data block storage in hard drive during the storage operation of the local machine is provided. When a file block is modified or deleted, the original block will not disappear because of the transaction, but a new block is created in addition to the existing one. Thus, the file block can return to any former state at any time, and even if the hard driver is damaged, it can be re-installed to a former state. Also, the patent also discusses the searching manner for promoting the efficiency moderately.

In U.S. Pat. No. 6,857,012 “Method and apparatus for initializing a new node in a network” published on Feb. 15, 2005, a method for initializing a newly added node is provided, wherein the nodes exist in the network in tree structure, a content required by the new node is searched quickly from the existing nodes and restored as a file block on the new node for initialization.

The above patents provide various applications directed to the present high-width transmission network, but no mechanism for accessing and managing personal data files by using the Internet is provided. Furthermore, how to improve the limited storage space of handheld mobile devices and fully use a high-bandwidth wireless transmission network to connect the Internet is not provided either.

### SUMMARY OF THE INVENTION

An object of the present invention is to provide a mechanism for accessing and managing files by using the Internet.

Another object of the present invention is to provide a mechanism applied in a handheld mobile device for being connected to the Internet by using a high-bandwidth wireless transmission network and extending its storage space.

Another object of the present invention is to provide a mechanism applied in a computer system with network connection capability for being connected to the Internet by using the high-bandwidth wireless transmission network and extending its storage space.

To achieve the above objects, the present invention provides a file access and management mechanism comprising a distributed virtual file system, wherein an application and an operation system access an original file through the distributed virtual file system. The mechanism further comprises multiple storage spaces. When the application stores a file through the distributed virtual file system, the original file is converted to multiple sliced file blocks after being processed by an encryption process and a slicing process, and each sliced file block is assigned with a corresponding parameter value. After determining the state of the storage spaces, the sliced file blocks are stored in the storage spaces in a predetermined sequence respectively, and storage information corresponding to the sliced file blocks are stored in the distributed virtual file system.

In above file management mechanism, assigning each sliced file block with a corresponding parameter value refers to arranging the sliced file blocks and giving a sequence number to each sliced file block in sequence.

In above file management mechanism, determining the state of a storage space comprises confirming whether the storage space is enough for storing the sliced file block or not, the network and system availability level of the storage space, the truth level of the storage space for a user, or the number of units of vacant space of the storage space.

In above file management mechanism, the mentioned storage spaces comprise storage spaces available on the Internet. The storage spaces available on the Internet may be storage spaces of large-capacity email boxes provided by web mail services, or storage spaces of network disks on the Internet.

In the above file access and management mechanism, under a priority mode, determining the state of the storage spaces comprises confirming whether the storage space is enough for storing the sliced file block or not, the network and system availability level of the storage space, the network and system availability level of the storage space being larger than the frequency level of using the original file, the truth level of the storage space for a user being larger than a weightiness parameter of the original file, and so on.

In above file access and management mechanism, it further comprises retrieving sliced file blocks from the storage spaces according to the storage information corresponding to the sliced file blocks stored in the distributed virtual file system when the application wants to retrieve the original file through the distributed virtual file system, and reverting them to the original file through an reversion process of the encryption process and the slicing process.

In above file access and management mechanism, when the application wants to delete the original file through the distributed virtual file system, check the sliced file blocks for the above storage spaces according to the storage information corresponding to the sliced file blocks stored in the distributed virtual file system, and directly delete the stored sliced file blocks.

In order to the make the aforementioned and other objects, features and advantages of the present invention comprehensible, a preferred embodiment accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of computer hosts or nodes connecting by the Internet under an Internet architecture.

FIG. 2 is a schematic view of an architecture for accessing and managing personal data files according to a preferred embodiment of the present invention.

FIG. 3 is a schematic view of a file processing algorithm according to a preferred embodiment of the present invention.

FIG. 4 is a flow chart of a file processing procedure and a processing procedure of a method for file blocks in an ordinary mode according to a preferred embodiment of the present invention.

FIG. 5 is a flow chart of a file processing procedure and a processing procedure of a method for distributing file blocks in a priority mode according to a preferred embodiment of the present invention.

### DESCRIPTION OF EMBODIMENTS

The present invention provides a mechanism for accessing data files through the Internet. Through a connection with the hard drive of the computer in one's family or company, and all free or paid storage spaces available on the Internet, such as web-mail box, web photo album with large capacity, and personal Blog, the carriable data quantity can be extended infinitely through a mobile device, such that users may feel like they have a limitless built-in storage capacity.

The mechanism for accessing and managing files through the Internet provided by the present invention can be applied in handheld mobile devices, to overcome the problem of limited storage space of the handheld mobile devices, and it can extend the storage space by fully using the trend of building-in a device for the high-bandwidth wireless network. Further, the mechanism can also be applied in a computer system with network connection capability, wherein the storage space thereof can be extended by connecting the computer system to the Internet with a high-bandwidth wireless transmission network.

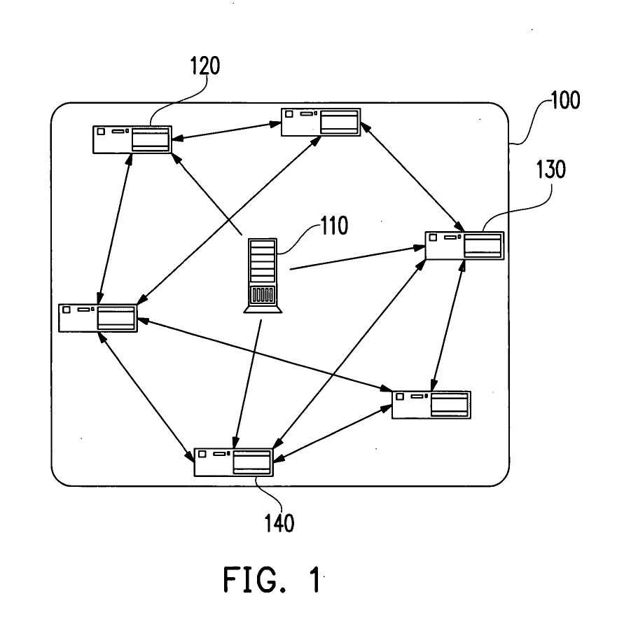

Referring to FIG. 1, under an Internet architecture 100, many computer hosts or nodes are connected together by the Internet, such as a computer host 110 and other computer hosts 120, 130, and 140. In early days, a Peer-to-Peer network data file sharing mechanism was provided. In this architecture, different date can be downloaded through other different hosts, such as the computer hosts 120, 130, and 140, and the computer host 110 is also a download point for data sharing. This architecture has become a popular trend for the Internet, and various mechanisms provided later, such as e-Donkey, e-Mule and Bit Torrent (BT), or network music file providers such as Kuro, Napster, are all similar architectures. However, the architectures are not applied in constructing a mechanism for accessing and managing personal data files.

The architecture of the present invention is a mechanism for accessing and managing files by fully using the Internet. For example, in an embodiment, the architecture provided by the present invention can use free or paid storage spaces available on the present Internet, for example, the storage spaces of large-capacity email boxes or network photo albums provided by web mail service providers such as MSN, GMail, Yahoo, and PCHome, and the most popular free personal Blogs, and the like. The storage spaces opened by the Internet are all storage spaces using the file access and management mechanism of the present invention, and can be extended infinitely. For example, in another embodiment, the architecture provided by the present invention can be implemented in multiple computers in a same group, such as computers in a same project, and the storage spaces are enlarged by the Internet connection.

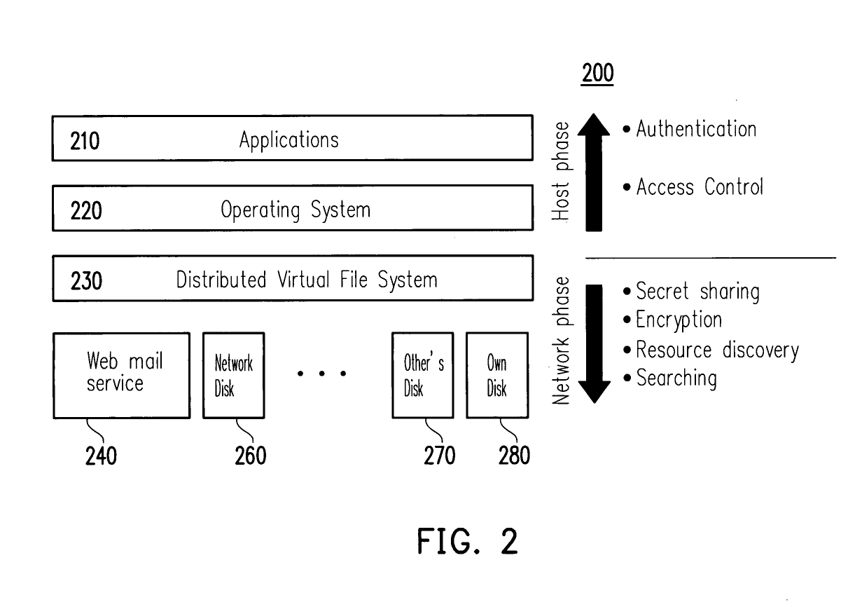

Referring to FIG. 2, it illustrates a file access and management architecture 200 according to a preferred embodiment of the present invention. The file access and management architecture 200 comprises an application 210, an operation system 220, a distributed virtual file system 230, and the like in the parts of host phase and network phase. In the architecture 200, free or paid storage spaces available on the Internet can be used, for example the web mail service 240 as shown in the drawing, e.g. the storage spaces of large-capacity email boxes provided by the service providers such as GMail, Yahoo, and PCHome, or the network disk 260 provided by some operators. Furthermore, the architecture can also be applied in multiple computers in the same group, such as others' disk 270 or own disk 280, and the storage spaces can be enlarged by the Internet connection.

In the part of host phase, an operation for accessing and managing files can be carried out in the enlarged storage space stored on the Internet through an authentication process and an access control process. In the network phase, if the file needs to be stored in the enlarged storage space of the Internet, in order to ensure the file content not to be revealed because of being stored in the public space, it should be processed by encryption. The stored file processed by encryption can further be processed with a secret sharing. The security process through key encryption and secret sharing has a security higher than that of a key algorithm only using an Advanced Encryption Standard (AES) or Data Encryption Standard (DES). Through the mechanism of storing in public space, the functions for resource discovery and searching are provided, and resources can be shared.

The mechanism for accessing and managing files through the Internet provided by the present invention has a large availability and convenience, and in particular, it can be applied in portable handheld electronic devices with the device for high-bandwidth wireless network built-in. The desired data can be retrieved through the network at any time and any place. Or otherwise, the mechanism can be applied in a computer system with network connection capability, and is capable of extending its storage space infinitely.

In the file access and management architecture 200 of this embodiment, the application 210, the operation system 220, and the distributed virtual file system 230 can be disposed in the same host, such as a desk-top computer or a notebook computer. Furthermore, in an alternative embodiment, the distributed virtual file system 230 can be disposed in a portable memory device, such as the current popular mobile disk, and is particularly applicable for the portable handheld electronic device. As long as inserting the mobile disk with a function of the distributed virtual file system 230 provided by the present invention, the portable handheld electronic device can access files through a connection, and enlarge the storage space infinitely.

Furthermore, the mechanism for accessing and managing files through the Internet should face different operation systems, therefore, the distributed virtual file system 230 can be disposed in, for example, a kernel program of the Unix operation system, or a driver of the Windows operating system.

The mechanism for accessing and managing files through the Internet provided by the present invention can use the free or paid storage space available on the Internet, such as the spaces of GMail, Yahoo, and even Blog. The accounts and log-in manner can be used without registering repeatedly after the user initiates a registration. The storing manner is completed by the file processing algorithm provided by the present invention. The files are arranged and assigned with unique codes after an encryption encoding and slicing process, and then stored in a suitable place, such that the files can be accessed in the future.

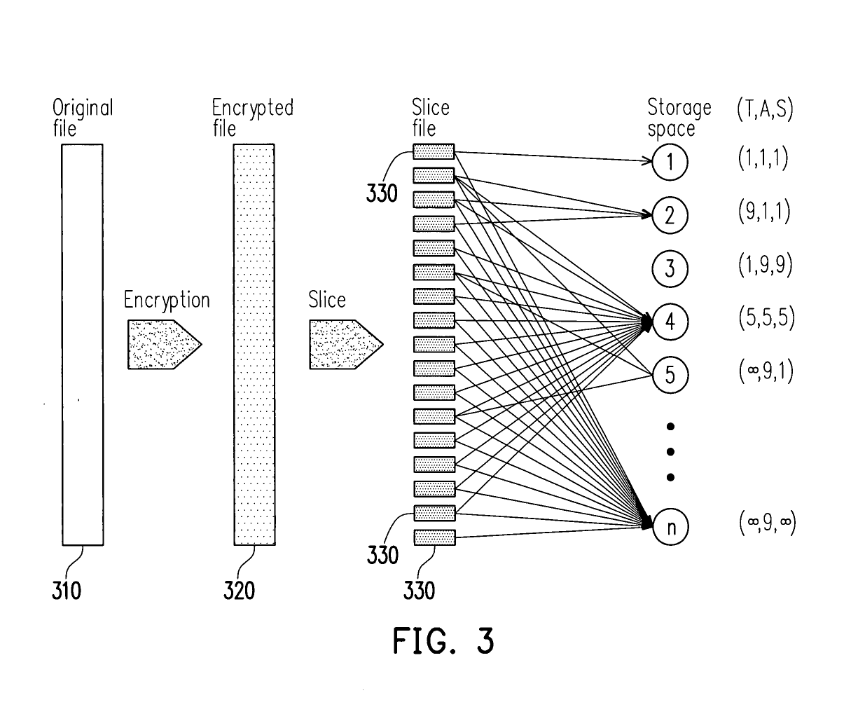

Referring to FIG. 3, an embodiment of the file processing algorithm provided by present invention is shown. Under an ordinary mode, besides considering how to slice the files efficiently and allocate them to the storage spaces on the network through the Internet, file security and privacy also should be taken into consideration. Under a priority mode, factors such as the file usage frequency and weightiness, and the network and system availability and truth of the storage space are further considered, to integratedly develop an efficient method for allocating blocks after slicing the file.

Referring to FIG. 3, the original file 310 is converted into an encrypted file 320 after being encrypted. And the encryption can be processed by the present well-known encryption algorithms, including AES, DES, and the like. Thereafter, the file can be sliced into multiple sliced files 330 according to design requirements. The size of each sliced storage unit and the number of the storage units depend on the network transmission speed and the number of available spaces.

Then, the mechanism for accessing and managing file through the Internet provided by the present invention gives different parameter settings according to different storage spaces, and storage spaces can be graded according to parameters, such as usage frequency, truth (indicated by “T” in the drawing), availability (indicated by “A” in the drawing), or the storage space size (indicated by “S” in the drawing). Subsequently, the sliced files 330 are stored directed to the storage space level. For example, as shown in FIG. 3, the sliced files are stored respectively by choosing different corresponding values of three parameters, i.e. truth, availability, and storage space size (T, A, S). For example, (T, A, S) of the No. 1 storage space is (1, 1, 1), and it is a comparison reference value. (T, A, S) of the No.2 storage space is (9, 1, 1), that is, the truth of the No. 2 storage space is 9 times of the truth of the No. 1 storage space, and other parameters are the same. (T, A, S) of the No. 3 storage space is (1, 9, 9), that is, the availability and size of the No. 3 storage space are 9 times of the availability and size of the No. 1 storage space, and the truth is the same. Infinity (indicated by “∞” in the drawing) indicates a value much higher than the reference value. According to the setting values, the sliced files 330 can be stored in different storage spaces.

According to the file processing algorithm of the embodiment in FIG. 3, files can be sliced efficiently, and each sliced file is assigned with a particular number, and allocated to a corresponding storage space through the Internet. Therefore, it is a perfect design for file security and privacy. If the file content is to be retrieved integrally, the locations of the sliced file blocks should be acknowledged other than the number of each sliced file blocks, therefore, this file processing algorithm comprises key encryption and secret sharing, and the security thereof is much higher than the process exclusively encrypting particular files. Besides, this embodiment provides a priority mode, for allocating the storage spaces by further considering factors such as file usage frequency and weightiness, and network system availability and truth of the storage space.

The file processing algorithm provided by the present invention is illustrated by the following embodiments.

At first, the Metadata value should be defined and calculated. The Metadata value is information describing the data property, with a main object to inform users how many Internet storage spaces are available, and how many spaces can be used. As shown by the following parameters:
modo: a big enough modulus, which is bigger than the number of the storages being used at the same time;
SKey: a symmetrical key used in encryption; and
Blksize: a data unit size of a file block.

And the following are the setting values of functions:

(1). File function ^{file(fname,fqn,wei,bkn,dgs,fbdy)}:

fname: file name;
fqn: frequency level of using the file;
wei: weightiness level of the file;
bkn: the number of sliced file blocks;
dgs: the hash digest about whether the file has been modified or not; and
fbdy: the body binary data part of the file.
   (2). File block function ^{block(fname,i,dup,bbdy)}:
ffiame: file name;
i: the i^{th} file block;
dup: duplication; and
bbdy: the body binary data part of the file block.
   (3). Storage space function ^{stg(sname,serial,avi,tru,vac)}:
sname: the storage space name;
serial: the serial number of the storage space;
avl: the network and system availability level of the storage space;
tru: the truth level of the storage space for the user; and
vac: vacant space uints.
   (4). Storage space index value function StgIndex(serial, nil, sname, avl, tru, vac)
serial: the serial number of the storage space
nil: whether the serial number is used by an actual storage or not, if nil=0, it means “yes”; if nil=1, it means “no”;
sname: the storage space name:
avl: the network and system availability level of the storage space;
tru: the truth level of the storage space for the user; and
vac: the number of units of vacant space.
   (5). File storage location function FileLoc (fname, fwhere)
fname: the file name
fwhere: a binary string having a mod length, for marking the storage spaces for all blocks of the file with this fname.

The following are setting values of the functions:

(1). Func-BinToA( ): Binary to American Standard Code for Information Interchange (ASCII), wherein ASCII is the standard for representing the English letters as numbers.

(2). Func-AToBin( ): ASCII to Binary

(3). Func-BlkDup( ):

file block function ^{block(dup)}=Func-Blkdup^{(file(fqn,wei)} ): the duplicated number of blocks generated according to the usage frequency level and weightiness level of the file
   (4). Func-SeriAgn( ):
storage space function ^{stg(serial)}=storage space function ^{stg(sname)} mod modo; check the storage space index function StgIndex(nil), if it collides with the existing storage serial number, increase the serial number sequentially.
   Initialization

During the initialization, define and calculate values of all metadata, including modo, SKey, Blksize, and the like, and further set:
file function ^{file(fname,fqn,wei,bkn,dgs,fbdy)}, except bkn;
file block function ^{block(frame,i,dup,bbdy)}, except i and bbdy;
storage space function ^{stg(sname,serial,avl,tru,vac)}; and
establish a table to store a storage space index function SteIndex(serial, nil, sname, avl, tru, vac).
   File Processing Procedure

The steps of the file processing procedure are as follows:
Step 1: calculate pfile=encryption function Encryption (SKey, ^{file(jbdy)});
Step 2: calculate bkn=^{┌Func-AToBin(pfile)/Blksize┐}, wherein the ┌┐ means choosing the upper value thereof, and write it back to the file function file( . . . ,bkn, . . . );
Step 3: slice the pfile to several file blocks, from file block function block(fname,1) to block(fname,bkn);
Step 4: create the file block function ^{block(fname,i,dup,bbdy)}.

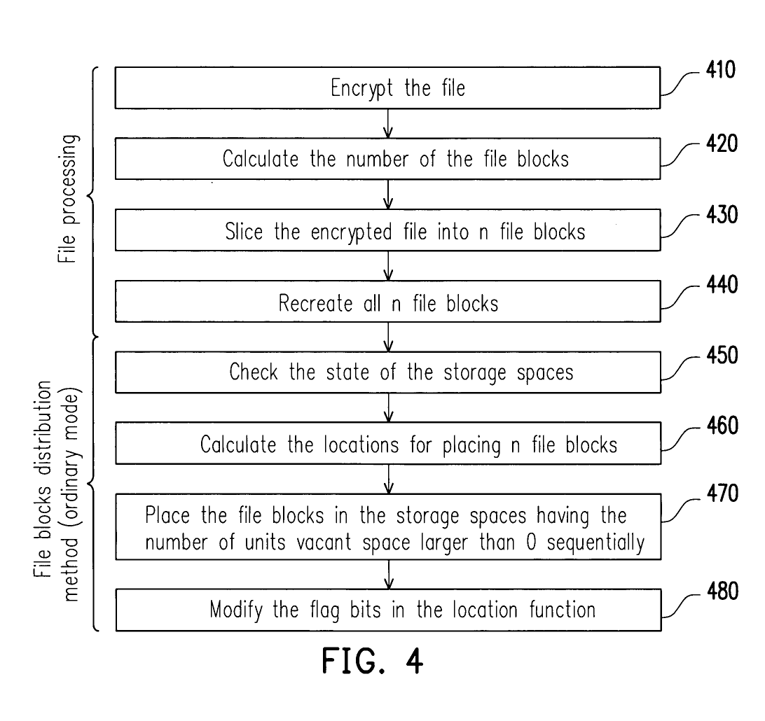

The part refers to the upper half of FIG. 4, which is the part of the file processing procedure. It comprises: encrypting the file in step 410, i.e. Step 1 described above; calculating the number of file blocks in step 420, i.e. Step 2 described above, and choosing the upper value; slicing the encrypted file into n file blocks, as Step 430; and recreating all n file blocks, as Step 440.

Block Distribution Steps in Basic Mode

Steps of distributing blocks under a basic mode are described as follows:
Step 1: check the storage space index function StgIndex value;
Step 2: for all file blocks ^{block(fname,i,dup,bbdy)} of the object file with the file name fnaame, perform the following procedures:
   from i=1 to bkn:
a) calculate the setting value toPuti=bbdy of ^{block(fname,i,dup,bbdy)} (mod modo) about the location for placing the block
b) sequentially place ^{block(dup)} copis of bbdy in stg(serical), wherein nil=0 and vac>0, in SteIndex from stg(serial)=toPuti.
c) modify the flag bits of fwhere parameter in FileLoc with the file name fname.

The part refers to the lower half of FIG. 4, which illustrates the processing procedure of the file blocks distribution method under an ordinary mode. In step 450, the state of the storage spaces is checked, such as serial number “serial”, nil value, name of the storage space “Sname”, network and system availability level of the storage space “avl”, the truth level of the storage space for the users “tru”, and the number of units of vacant space “vac”. Then, in Step 460, the locations for placing the n file blocks are calculated. In step 470, the file blocks are sequentially placed in the storage space with vacant spaces (nil=0) and the number of units of vacant space vac>0. In Step 480, the flag bits parameter of the fwhere parameter in FileLoc with the file name fname is modified.

Block Distribution Steps in Priority Mode

Steps of distributing the blocks in priority mode are described as follows:
Step 1: check the StgIndex;
Step 2: for the file blocks ^{block(fname,i,dup,bbdy)} of the object file with the file name fname, perform the following procedures:
   For i=1, . . . ,bkn:
a) calculate the setting value toPuti=bbdy of ^{block(fname,i,dup,bbdy)} (mod modo) about the location for placing the block
b) sequentially place ^{block(dup)} copies of bbdy in the StgIndex from stg(serial)=toPuti, which satisfies the following conditions:
stg (serial) with nil=0 and the number of units of vacant space vac>0;
the network and system availability level of storage space avl>the frequency level of using the file fqn;
the truth level of the storage space for the user tru>the weightiness parameter of the file wei
c) modify the flag bits of fwhere parameter in the FileLoc with the file name fname.

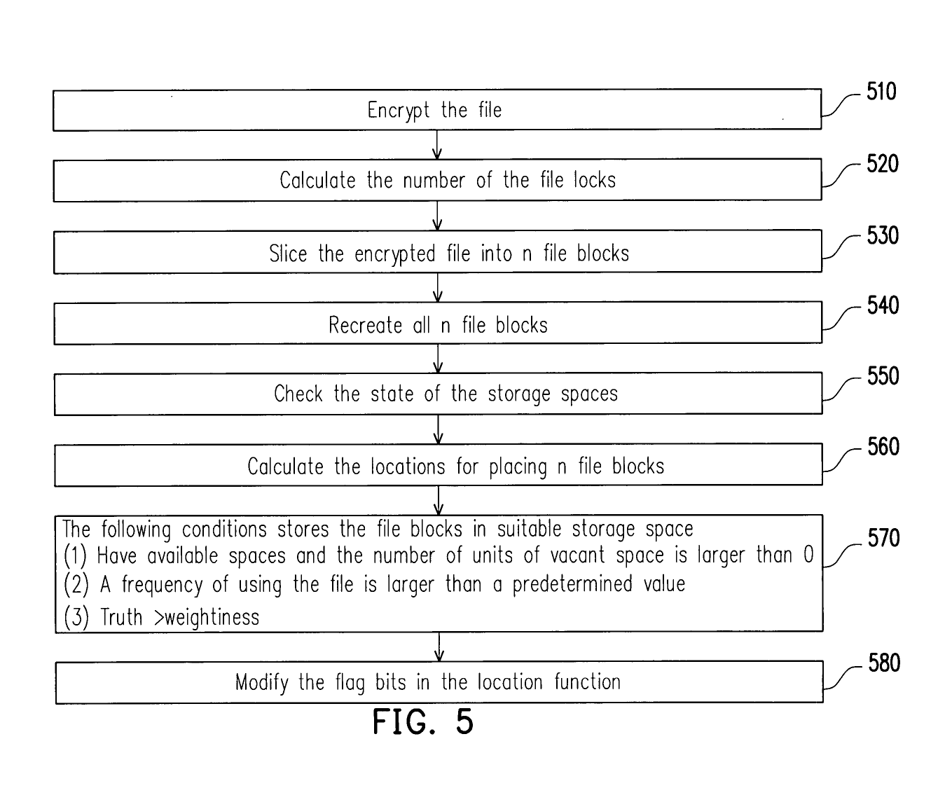

This part is described with reference to FIG. 5. The Steps 510˜540 in FIG. 5 illustrate the file processing procedure the same as that in FIG. 4, comprising: encrypting the file in Step 510; calculating the number of the file blocks in Step 520; slicing the encrypted file into n file blocks in Step 530; and recreating all n file blocks in Step 540. And then, the steps of distributing the blocks in the priority mode are illustrated. In Step 550, the state of the storage spaces are checked, such as the storage space serial number “serial”, nil value, the storage space name “sname”, the network and system availability level of the storage space “avl”, the truth level of the storage space for the user “tru”, and the number of units of vacant space “vac”. In Step 560, the locations for placing the n file blocks are calculated. Then in Step 570, the file blocks are placed in corresponding storage spaces according to the following conditions, including: (1) stg (serial) with nil=0 and the number of units of vacant space vac>0; (2) the network and the system availability level of the storage space avl>frequency level of using the file; and (3) the truth level of the storage space for the user tru>the file weightiness parameter wei. And in step 580, the flag bits parameter of fwhere parameter in the FileLoc with the file name fname is modified.

### BLOCK RETRIEVAL

If the file stored in the Internet is to be retrieved, for example, the file with a target file name as “fname” is to be retrieved, the data can be retrieved according to the following steps. First, check the file storage location function FileLoc, and obtain the fwhere parameter value corresponding to the file name “fname”. Then inquire all storage spaces with the flag bit of 1 to retrieve all the file blocks corresponding to the file name “fname”. And arrange and revert all file blocks to the former encrypted file, according to a reversion step of the sliced files. Then carry out the decryption procedure to obtain a file with the target file name as “fname”, according to the reversion of the former encryption step.

### BLOCK DELETION

If a file stored on the Internet is to be deleted, for example, a file with a target file name as “fname” is to be deleted, the data can be retrieved according the following steps. At fist, check the file storage location function FileLoc, and obtain the fwhere parameter value corresponding to the file name “fname”. Then inquire all storage space with a flag bit of 1, and delete all file blocks corresponding to the file name as “fname”.

In a file access and management mechanism over Internet provided by the present invention, the present invention provides a method for distributing files in arbitrary (incontrollable) storage spaces, and maintaining the file security in aforementioned storage spaces. In addition, the present invention also provides a method for maintaining the file availability in the aforementioned storage spaces, a conversion manner between a network address and a virtual storage space address, and an addressing manner for determining addresses for placing file fragments. The above storing manner also considers parameters at least including truth, availability, and size for choosing the storage space. And the present invention further provides a method for retrieving and deleting file fragments.

In the mechanism for accessing and managing personal data files through the Internet provided by the present invention, through a connection with the hard drive at one's family or company, and all free or paid storage spaces available on the Internet, the carriable data quantity can be extended infinitely through a mobile device, such that the user feels like he or she has a limitless built-in storage capacity. The mechanism for accessing and managing personal data files through the Internet provided by the present invention also can be applied to the handheld mobile devices to overcome the problem of limited storage space of the handheld mobile devices, and it can extend the storage space by fully using the trend of building-in the device for high-bandwidth wireless networking. Furthermore, the mechanism can also be applied to computer systems with network connection capability, for extending its storage space infinitely by connecting the computer system to the Internet with the high-bandwidth wireless transmission network.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A file access and management mechanism, comprising:
a distributed virtual file system, wherein an application and an operation system access a original file through the distributed virtual file system; and
multiple storage spaces, wherein when the application stores the original file through the distributed virtual file system, the original file is converted to multiple sliced file blocks after being processed by an encryption process and an slicing process, and each of the sliced file blocks is assigned with a corresponding parameter value, and the sliced file blocks are stored in the storage spaces in a predetermined sequence after determining the state of the storage spaces, and storage information corresponding to the sliced file blocks are stored in the distributed virtual file system.

2. The file management mechanism as claimed in claim 1, wherein assigning each of the sliced file blocks with a corresponding parameter value refers to arranging the sliced file blocks for giving each sliced file block a sequence number in sequence.

3. The file access and management mechanism as claimed in claim 1, wherein determining the state of the storage spaces comprises confirming whether the storage space is enough for storing the sliced file block.

4. The file access and management mechanism as claimed in claim 1, wherein determining the state of the storage spaces comprises confirming a network and system availability level of the storage space.

5. The file access and management mechanism as claimed in claim 1, wherein determining the state of the storage spaces comprises confirming the truth level of the storage space for a user.

6. The file access and management mechanism as claimed in claim 1, wherein determining the state of the storage spaces comprises confirming the number of units of vacant space of the storage space.

7. The file management mechanism as claimed in claim 1, wherein the storage spaces comprise storage spaces available on the Internet.

8. The file management mechanism as claimed in claim 7, wherein the storage spaces comprise storage spaces of large-capacity email boxes provided by a web mail service on the Internet.

9. The file management mechanism as claimed in claim 7, wherein the storage spaces comprise storage spaces of network disks on the Internet.

10. The file access and management mechanism as claimed in claim 1, wherein if it is under a priority mode, determining the state of the storage spaces comprises confirming the following states:
whether the storage space is enough for storing the sliced file block or not, and the network and system availability level of the storage space,
the network and system availability level of the storage space being larger than the frequency level of using the original file, and a truth level of the storage space for a user being larger than the weightiness parameter of the original file.

11. The file access and management mechanism as claimed in claim 1, further comprising:
when the application wants to retrieve the original file through the distributed virtual file system, retrieving the sliced file blocks from the storage spaces according to the storage information corresponding to the sliced file blocks stored in the distributed virtual file system, and reverting them to the original file through an reversion process of the encryption process and the slicing process.

12. The file access and management mechanism as claimed in claim 1, further comprising:
when the application wants to delete the original file through the distributed virtual file system, checking the sliced file blocks for the storage spaces according to the storage information corresponding to the sliced file blocks stored in the distributed virtual file system, and directly deleting the stored sliced file blocks.

13. A method for accessing and managing files, comprising:
encrypting a original file, to obtain an encrypted file;
slicing the encrypted file into multiple file blocks;
arranging the file blocks and assigning each file block with a corresponding sequence number;
calculating the locations for placing the file blocks after checking the state of the storage spaces, and placing the file blocks at multiple network storage spaces having available spaces and the number of units of vacant space larger than 0; and
modifying a storage information corresponding to the original file.

14. The file access and management method as claimed in claim 13, wherein when the original file is to be retrieved, the sliced file blocks are retrieved from the network storage spaces according to the storage information of the original file, and reverted into the original file through a reversion process of the encryption process and the slicing process.

15. The file access and management method as claimed in claim 13, further comprising:
when the original file is to be deleted, checking the sliced file blocks for the network storage spaces according to the storage information, and directly deleting the stored sliced file blocks.

16. A method for accessing and managing files, comprising:
encrypting a original file, to obtain an encrypted file;
slicing the encrypted file into multiple file blocks;
arranging the file blocks and assigning each file block with a corresponding sequence number;
calculating the locations for placing the file blocks after checking the state of multiple storage spaces, wherein checking the state of the storage spaces comprises confirming whether the storage space is enough for storing the sliced file block, the network and system availability level of the storage space, the network and system availability level of the storage space being larger than the frequency level of using the original file, and the truth level of the storage space for a user being larger than the weightiness parameter of the original file;
placing the file blocks at the network storage spaces; and
modifying a storage information corresponding to the original file.

17. The file access and management method as claimed in claim 16, wherein when the original file is to be retrieved, the sliced file blocks are retrieved from the network storage spaces according to the storage information of the original file, and reverted to the original file through the reversion process of the encryption process and the slicing process.

18. The file access and management method as claimed in claim 16, further comprising: when the original file is to be deleted, checking the sliced file blocks for the network storage spaces according to the storage information, and directly deleting the stored sliced file blocks.
